(19) United States
(12) Patent Application Publication
(10) Pub. No.: US 2015/0047713 A1
(43) Pub. Date: Feb. 19, 2015

(54) Method and Device for Removing Water From a Swimming Pool Cover

(71) Applicant: Joseph T. Acklin, Carmel, IN (US)

(72) Inventor: Joseph T. Acklin, Carmel, IN (US)

(21) Appl. No.: 13/967,033

(22) Filed: Aug. 14, 2013

(51) Int. Cl. F17D 1/14; E04H 4/16

(52) U.S. Cl. CPC F17D 1/14; E04H 4/16
USPC 137/15.01; 137/565.01

(57) ABSTRACT

A device and method is provided for removing water that has accumulated on a swimming pool cover in the form of a directed stream or spray from a typical pool cover pump through a water ejection spout. The water ejection spout has a connector adapted to couple to an outflow connector of the pool cover pump, tubing extending from the connector, and a nozzle coupled to the tubing for expelling the pumped water. The water ejection spout is configured to discharge the pumped water in a directed stream or spray upwardly and outwardly from the pool cover pump. The tubing and nozzle may be configured to additionally discharge the pumped water in a directed stream or spray away from the pool pump, or another in a directed stream or spray over the pool pump. One form is configured to inhibit rotation and/or tipping of the pump/spout assembly.

### FIELD OF THE INVENTION

The present invention relates to methods and devices for removing water from a swimming pool cover and, more particularly, to methods and devices for removing water from a swimming pool cover using a swimming pool cover pump.

### BACKGROUND

Many swimming pools have covers for keeping dirt, debris and other undesirable elements from getting into the pool. Covers also keep children from falling into the pool when the pool is unattended, and unauthorized people from entering the pool. Covers are thus made to withstand substantial weight so that if someone were to fall or walk onto the cover it would hold their weight.

However, because of the various purposes of a swimming pool cover, they are made such that they are impermeable to water. Therefore, water, generally because of rain, accumulates on the swimming pool cover. In order to use the swimming pool, any water on the cover must first be removed before the cover can be manually taken off or automatically rolled back. The prior art manner of removing water from a pool cover is to use a pool cover pump.

FIG. 1 shows a typical swimming pool 10 with a cover 12. While the cover 12 is shown as an automatic type pool cover, it should be appreciated that the same prior art method applies to manual type pool covers. An accumulation of water 14 is shown on the cover 12. A typical pool cover pump 16 has been placed in the accumulation of water 14. The pool cover pump 16 operates via electricity and thus includes a power cord 17 that is connected to a source of electricity (not shown). The pump 16 has a connector 19 through which the water is pumped. The pump connector 19 is configured (i.e. threaded) such that a typical hose 18 can be connected to the pump 16. This setup guides the accumulated water 14 from the cover 12 and out the hose 18.

While the prior art manner of removing water from a swimming pool cover certainly works, there are many associated hassles, particularly with the hose and the water being removed. First, a hose of sufficient length to channel the water to a desired outflow area must be connected to the pool cover pump, and secondly, the hose 18 must be connected to the pool cover pump, stretched out and appropriately placed such that the pumped water flows into the desired outflow area. This procedure must be accomplished every time accumulated water is removed from the pool cover.

Moreover, the water being removed flows from the hose 18 in a large continuous stream. As such, the continuous stream of water from the hose is not well suited for anything other than wasting the water. If the hose is placed such that the continuous stream of water outflows into a yard, the outflow area will quickly become saturated.

In view of the above, what is therefore needed is a better manner of removing accumulated water from a swimming pool cover.

### SUMMARY OF THE INVENTION

The present invention is a device and method of removing accumulated water from a swimming pool cover that ejects, expels and/or disperses outflowing water from a pool cover pump in the form of a directed stream or spray.

The device comprises a water ejection spout having a connector adapted to couple to an outflow connector of a pool cover pump, tubing extending from the connector, and a nozzle coupled to the tubing and having an orifice for expelling water being pumped by the pool cover pump, the tubing and nozzle configured to discharge the pumped water in a directed stream or spray upwardly and outwardly from the pool cover pump.

In one form, the tubing and nozzle are configured to additionally discharge the pumped water in a directed stream or spray away from the pool pump.

In another form, the tubing and nozzle are configured to additionally discharge the pumped water in a directed stream or spray over the pool pump.

The tubing may comprise one or more tube sections. Additionally, the tubing may include one or more angled portions.

The method of removing accumulated water from a swimming pool cover includes providing a water ejection spout as described herein, attaching the provided water ejection spout to a pool cover pump, and activating the pool cover pump.

### BRIEF DESCRIPTION OF THE DRAWINGS

FIG. 1 is an illustration of a prior art manner of removing water from a pool cover using a pool cover pump.

FIG. 2 is an illustration of a manner of removing water from a pool cover using a pool cover pump in accordance with the principles of the present invention, the present manner of removing water from a pool cover using a water ejection spout.

FIG. 3 is another embodiment of a water ejection spout fashioned in accordance with the present principles.

FIG. 4 is an illustration of the present manner of removing water from a pool cover using a pool cover pump with another embodiment of a water ejection spout.

FIG. 5 is an enlarged view of the water ejection spout connected to the pool cover pump as shown in FIG. 4.

FIG. 6 is an enlarged view of another embodiment of a water ejection spout fashioned in accordance with the present principles.

FIG. 7 is a view of a rotating nozzle for the present water ejection spouts according to the present principles.

FIG. 8 is a view of another water ejection spout fashioned in accordance with the present principles connected to a pool cover pump.

FIG. 9 is a view of another water ejection spout fashioned in accordance with the present principles connected to a pool cover pump.

FIG. 10 is an enlarged view of connecting portions of the water ejection spout of FIG. 9.

### DETAILED DESCRIPTION

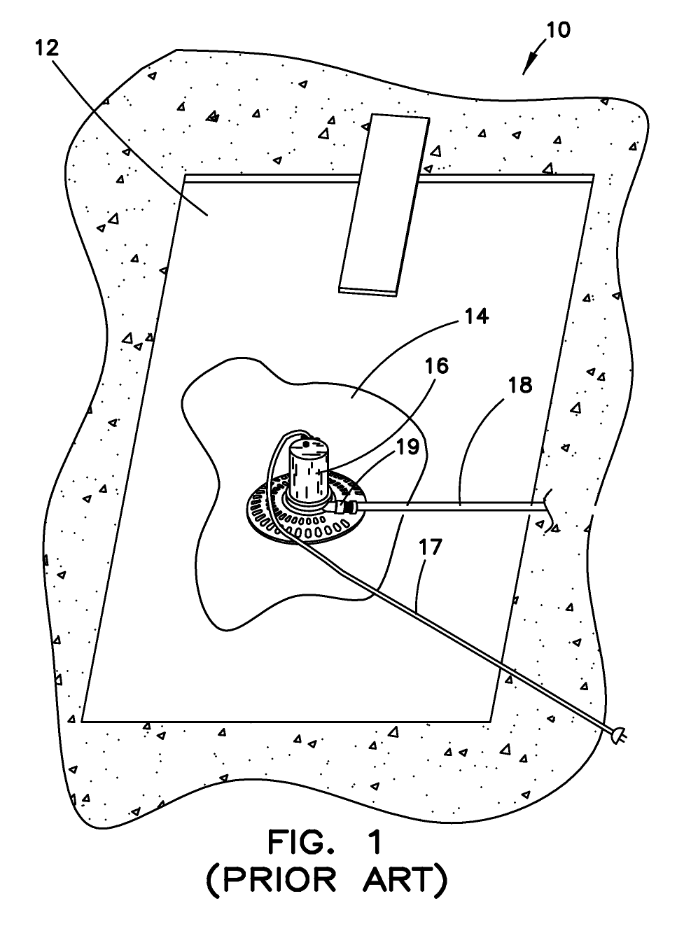

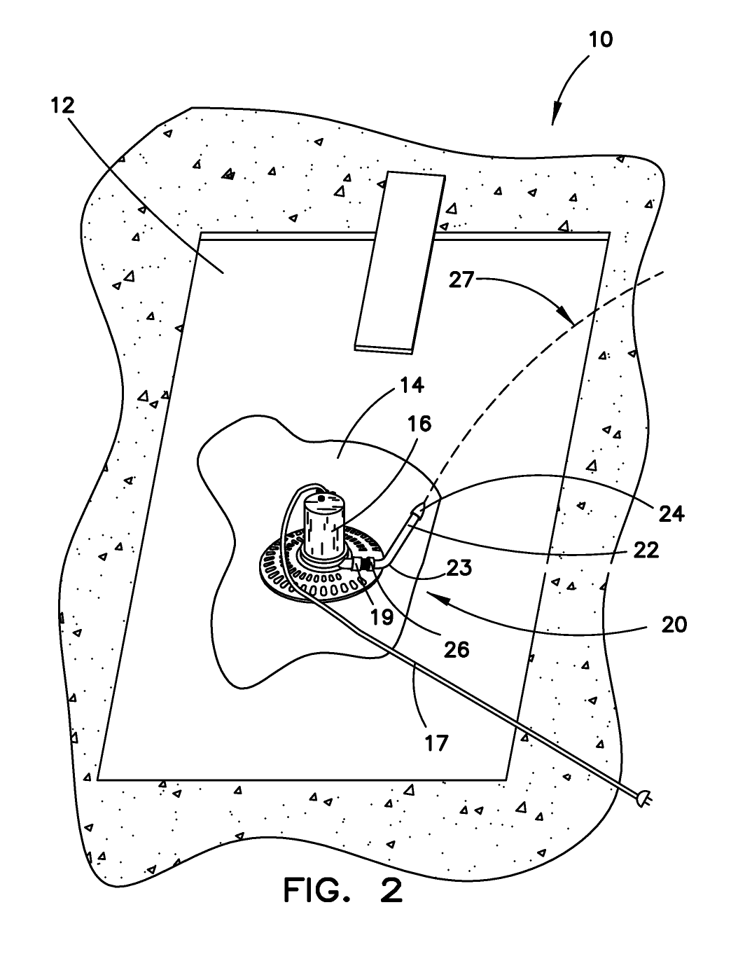

Referring to FIG. 2, there is shown the typical swimming pool 10 with a cover 12 as depicted in FIG. 1. While the cover 12 is shown as an automatic type pool cover, it should be appreciated that the present method and associated device applies to manual type pool covers. An accumulation of water 14 is shown on the cover 12. A typical pool cover pump 16 has been placed in the accumulation of water 14. The pool cover pump 16 operates via electricity and thus includes a power cord 17 that is connected to a source of electricity (not shown). The pump 16 includes a connector 19 through which the accumulated water is pumped.

In accordance with the principles of the present invention, an exemplary embodiment of a water ejection spout 20 is connected to the pool cover pump 16. The water ejection spout 20 is configured to expel and/or disperse the accumulated water in a stream 27. The water ejection spout 20 includes a length of tube/tubing, conduit, pipe/piping, or the like (collectively, tube) 22 that is preferably, but not necessarily, made from a plastic such as PVC. Other types of plastic and materials may be used if desired. Moreover, the tube 22 may be semi-rigid or bendable if desired. The length of tube 22 projects upwardly and outwardly from an angled portion 23 which in turn, is coupled to a connector 26. The connector 26 is threaded for attachment to the pump connector 19. A nozzle 24 is situated at an end of the tube 22. The nozzle 24 is configured to eject, expel and/or disperse the outflowing stream of water 27 a distance away from the pool 10 and the pool cover 12. As such, the stream of water 27 is well suited for watering the lawn, directing the water to a desired outflow area, or otherwise controllably discharging the pumped water.

Because the water ejection spout 20 is rigid (or at least semi-rigid) the pool pump 16 and thus the water ejection spout 20 is easily positionable on the pool cover 12 such that the direction of the water stream 27 is easily controlled. Thus, instead of moving a cumbersome hose, only the pool pump 16 needs to be turned or otherwise positioned in order to direct the water stream 27 as desired.

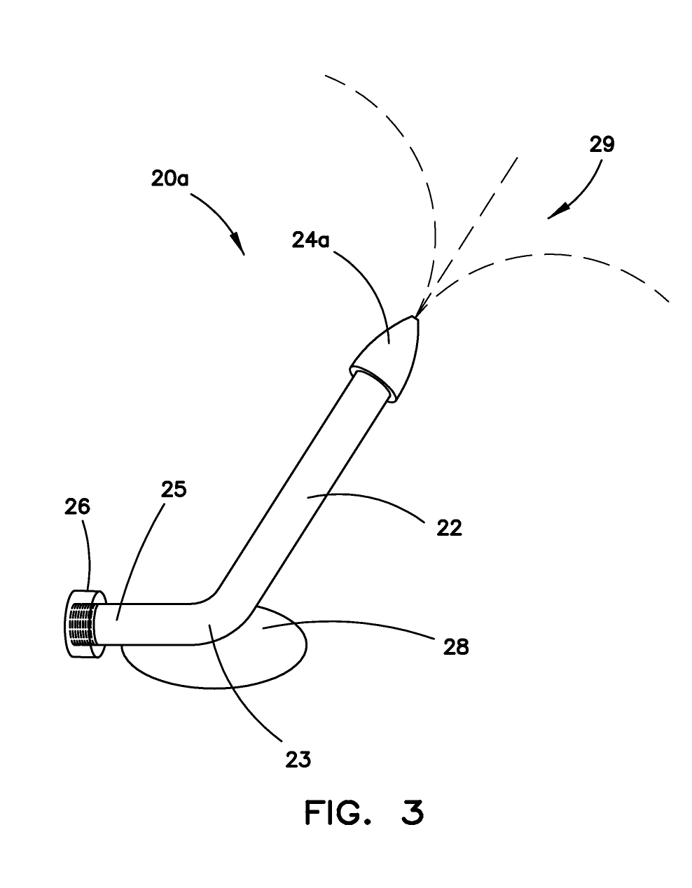

Referring now to FIG. 3, there is depicted another embodiment of a water ejection spout 20a fashioned in accordance with the present principles that is connectable to the pool cover pump 16 (not shown in FIG. 3). The water ejection spout 20a is configured to expel and/or disperse the accumulated water in a spray 29. The water ejection spout 20a includes the length of tube 22 like the water ejection spout 20. The length of tube 22 projects upwardly and outwardly from the angled portion 23 which in turn, is coupled to the connector 26 via an extended length of tube 25. The connector 26 is threaded for attachment to the pump connector 19. A nozzle 24a is again situated at an end of the tube 22. The nozzle 24a is configured to eject, expel and/or disperse the outflowing spray of water 29 a distance away from the pool 10 and the pool cover 12. As such, the spray of water 29 is well suited for watering the lawn, directing the water to a desired outflow area, or otherwise controllably discharging the pumped water.

The water ejection spout 20a includes a base 28 on which the extended length of tube 25 and the angled portion 23 rests. The base 28 provides extra stability to the water ejection spout 20 to inhibit and/or prevent it from tipping over. Because the water ejection spout 20a is rigid (or at least semi-rigid) the pool pump 16 and thus the water ejection spout 20a is easily positionable on the pool cover 12 such that the direction of the water spray 29 is easily controlled. Thus, instead of moving a cumbersome hose, only the pool pump 16 needs to be turned or otherwise positioned in order to direct the water spray 29 as desired.

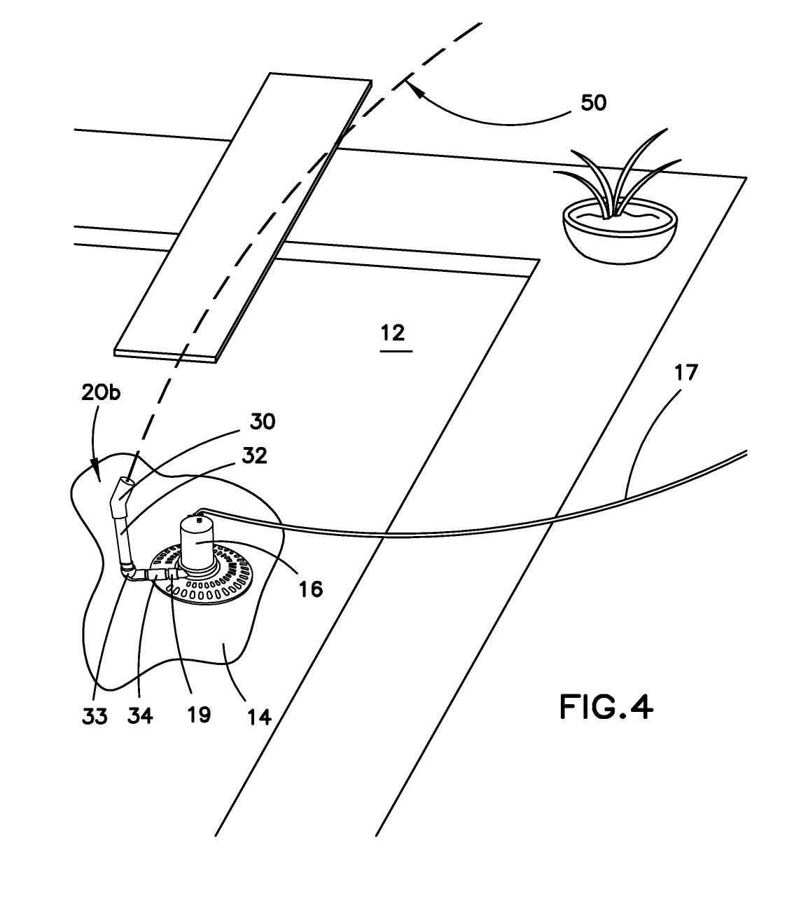

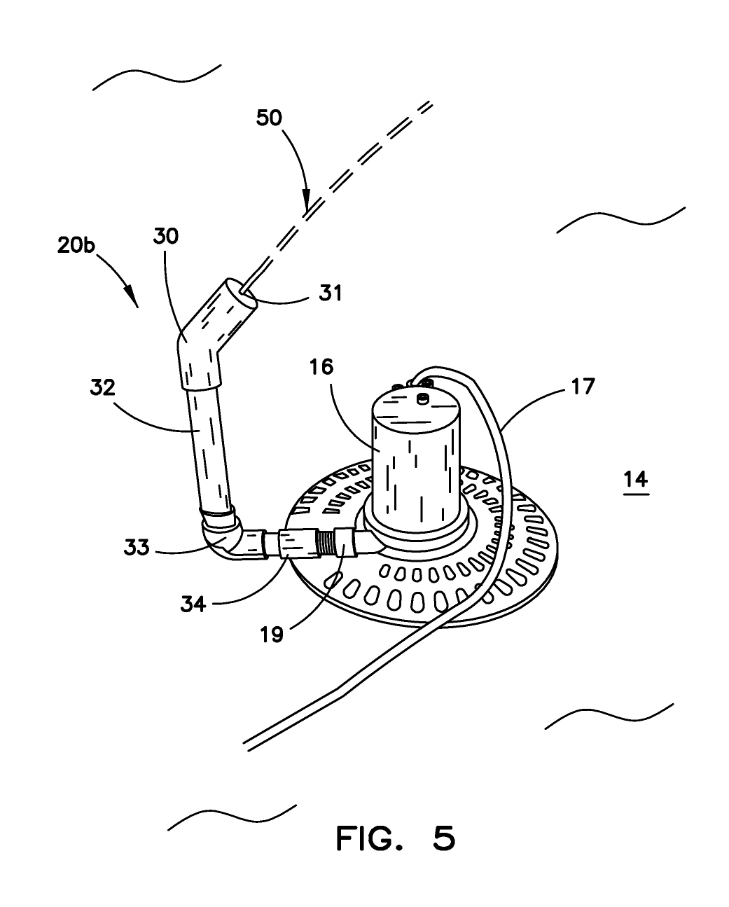

Referring now to FIGS. 4 and 5, there is shown another exemplary embodiment of a water ejection spout 20b fashioned in accordance with the present principles that is connectable to the pool cover pump 16. The water ejection spout 20b is configured to expel and/or disperse the accumulated water in a stream 50. In this embodiment, rather than expelling the water upwardly, outwardly and away from the pump as per the water ejection spouts 20 and 20a, the water is expelled upwardly, away and over the pool pump 16. This helps to inhibit or prevent the force of the expelled water from rotating or otherwise affecting the position of the pump 16.

The water ejection spout 20b includes connector 34 that is configured for threaded connection with the pump connector 19. An elbow 33, providing a right angle joint, is attached to the end of the connector 34. A length of tube 32 projects upwardly from the elbow 33. A nozzle 30 having a nozzle opening 31 is situated at an end of the tube 32. The nozzle 30 is angled such that the ejected outflowing stream of water 50 flows upwardly, outwardly and over the pump 16 a distance away from the pool 10 and the pool cover 12. As such, the stream of water 50 is again well suited for watering the lawn, directing the water to a desired outflow area, or otherwise controllably discharging the pumped water. The direction of the ejected stream of water 50 counteracts any force exerted on the spout 20b and the pump 16 such that the pump 16 will not rotate or be moved thereby.

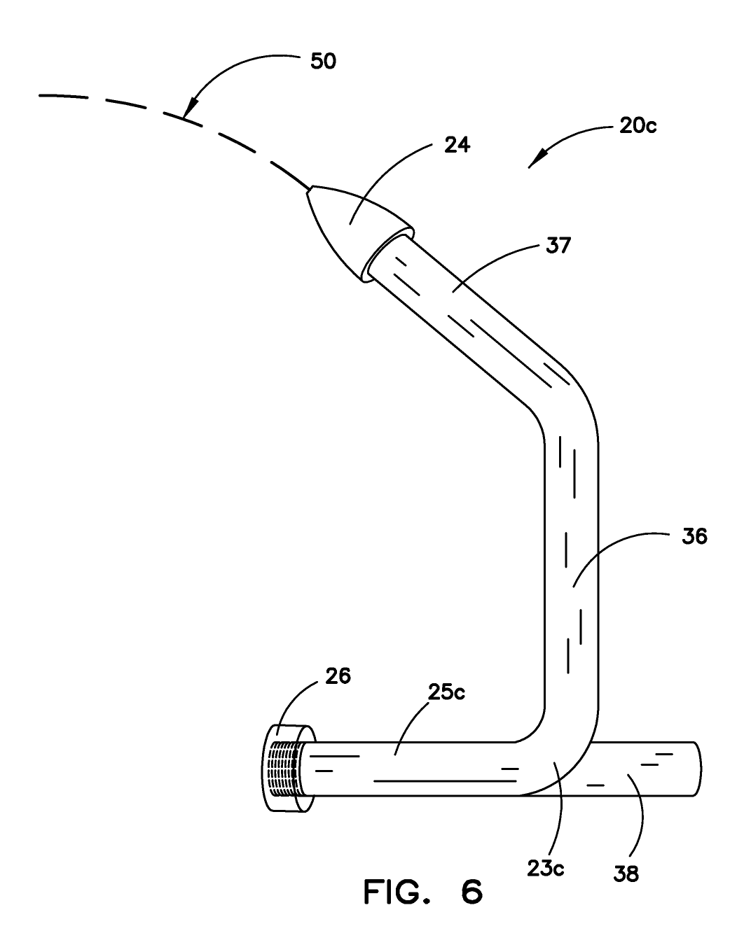

Referring now to FIG. 6, there is depicted yet another exemplary embodiment of a water ejection spout 20c fashioned in accordance with the present principles that is connectable to the pool cover pump 16 (not shown in FIG. 6). The water ejection spout 20c, like the water ejection spout 20b, ejects, expels and/or disperses the water upwardly, away and over the pool pump 16. The water ejection spout 20c has a threaded connector 26 for connection to the pump connector, a straight length of tube 25c coupled to the connector 26, an angled portion 23c that provides a generally 90° bend, a second straight length of tube 36 extending upwardly from the angled portion 23c, and a third straight length of tube 37 that extends from the second length of tube 36 at an angle such that the nozzle 24 ejects a stream of water 50 upwardly, away from and over the pump (not shown in FIG. 6). The water ejection spout 20c further includes an extension 38 that projects from the straight length of tube 25c to provide stability to the water ejection spout 20c.

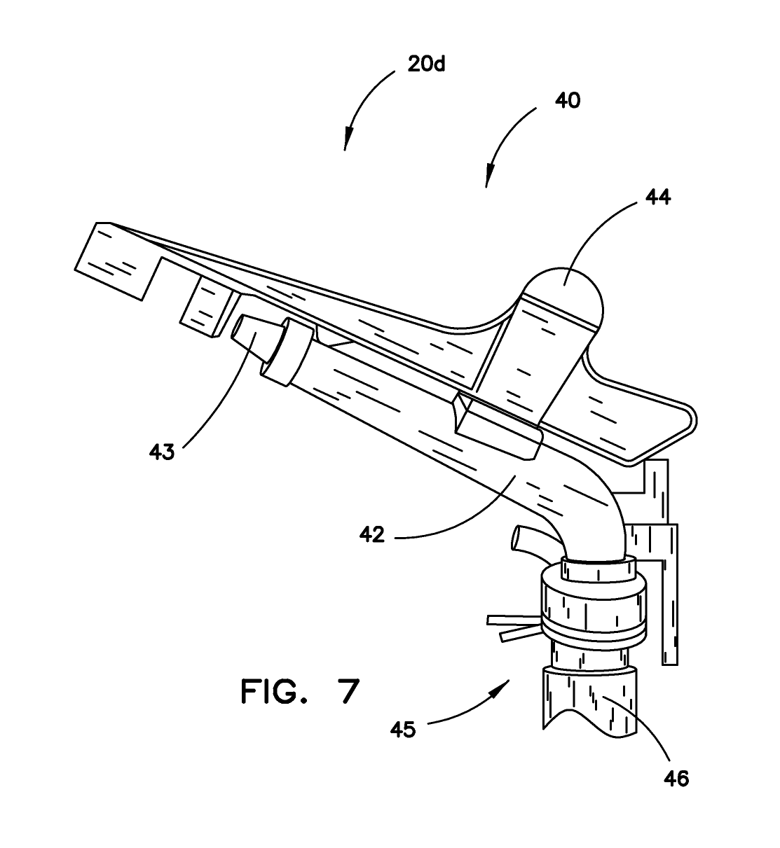

Referring now to FIG. 7, there is shown an alternate nozzle 40 for yet another exemplary embodiment of a water ejection spout 20d. While the nozzle 40 is described with respect to the water ejection spout embodiment 20d, it should be appreciated that the nozzle 40 may be used on any of the water ejection spouts described herein. The nozzle 40 is also representative of nozzles that provide a moving or adjustable spray or stream of water from the water ejection spout.

The nozzle 40 is illustrated as a typical rotating (moving) spray head. The nozzle 40 is situated on an end of a tube section 46 of the water ejection spout 20d. A curved tube section 42 extends from the tube section 46 and terminates in a water ejection head 43. A spring/rotation mechanism 45 is provided that is coupled to an actuating arm 44. Pressure from the ejected water causes the nozzle 40 to rotate as desired.

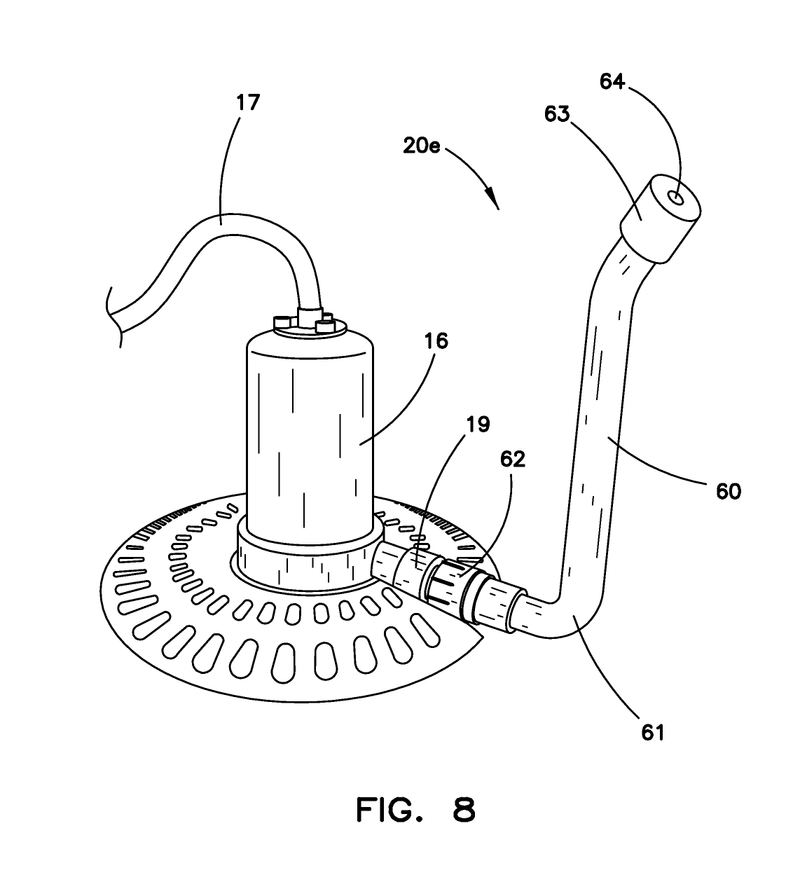

Referring now to FIG. 8, there is depicted a further embodiment of a water ejection spout 20e fashioned in accordance with the present principles that is connected to the pool cover pump 16. The water ejection spout 20e is configured to expel and/or disperse the accumulated water in a stream (not shown). The water ejection spout 20e includes a threaded connector section 62 that is configured for attachment to the threaded pump connector 19. An angled section 61 extends upwardly and slightly outwardly from the connector section. A length of generally linear (straight) tube 60 extends from the angled section 61 and includes an outward bend at its distal end. A nozzle 63 have an orifice 64 is situated at the end of the bend. The nozzle 63 is configured to eject, expel and/or disperse the outflowing stream of water (not shown) a distance away from the pool 10 and the pool cover 12.

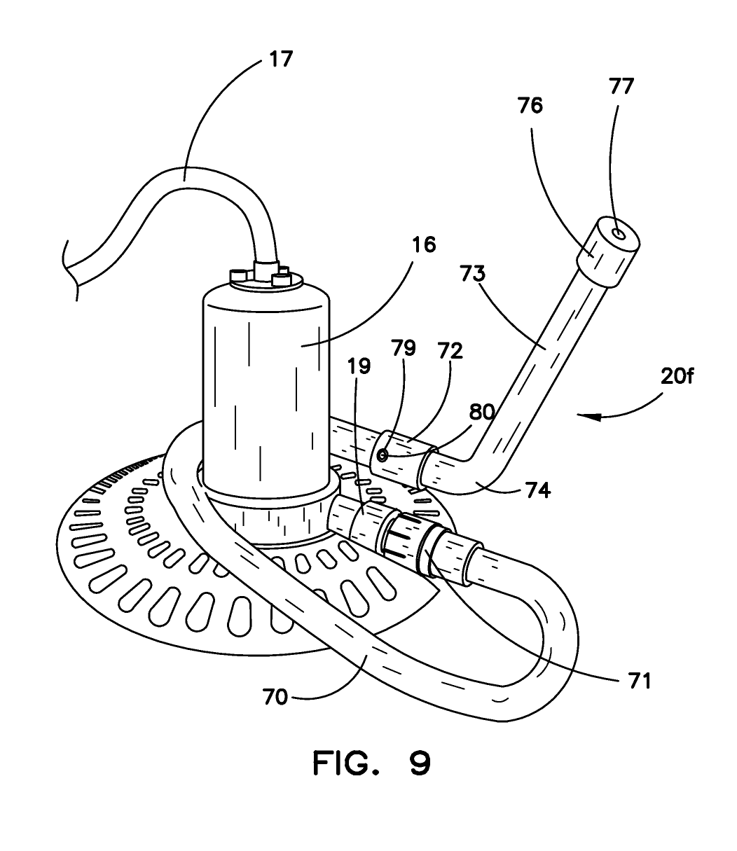

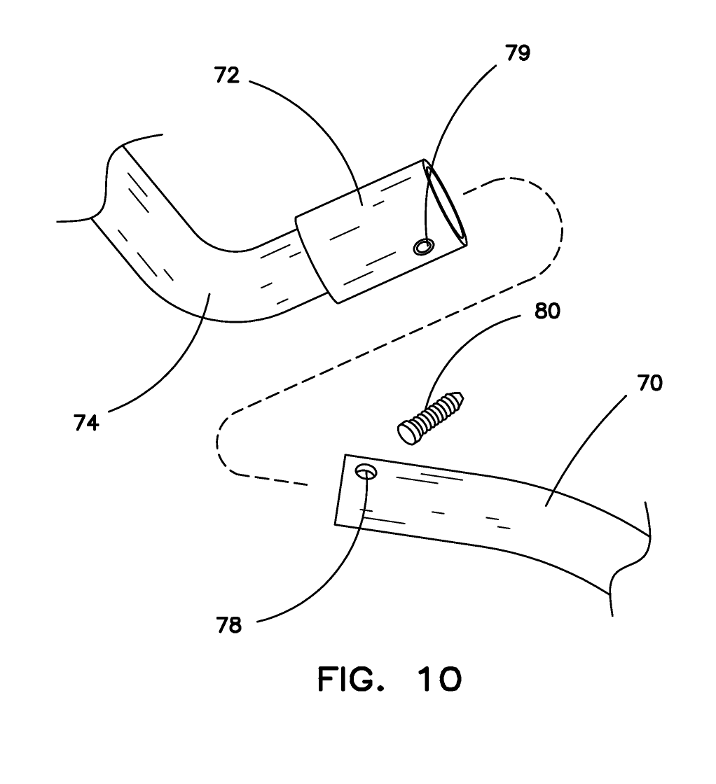

Referring to FIGS. 9 and 10, there is depicted a still further embodiment of a water ejection spout 20f fashioned in accordance with the present principles. The water ejection spout 20f is configured to address any possible rotation and/or tipping of the pool pump and connected water ejection spout that can be caused by the pressure of the outflowing water stream or spray. The water ejection spout 20f thus provides a water ejection spout that is anti-rotation and anti-tipping to the pump/spout configuration.

The water ejection spout 20f includes a threaded connector 71 that is configured to couple to the threaded pump connector 19. A first tube 70 extends from the connector 71 and is shaped to wrap around the pump 16. The first tube 70 has a bore 78 at its distal end. A second tube 73 having a bend 74 and a tube connector 72 at one end is adapted to allow connection of the first tube 70. The tube connector 72 has a bore 79 that aligns with the bore 78 of the first tube 70. A pin 80 or similar device is received in the bores 79 and 80 in order to secure the two tubes 70, 74 together. The tubes/tube sections 70 and 73 are separate to aid in packaging and/or storage of the water ejection spout 20f.

Those of skill in the art will understand that various details of the present invention may be changed without departing from the spirit and scope of the invention. Furthermore, the foregoing description is for illustration only, and not for the purpose of limitation, the invention being defined by the claims. Moreover, the various features of the various embodiments shown and described herein may be interchanged as desired.

While the invention has been illustrated and described in detail in the foregoing drawings and description, the same is to be considered as illustrative and not restrictive in character, it being understood that only illustrative embodiments thereof have been show and described and that all changes and modifications that are within the scope of the following claims are desired to be protected.

All references cited in this specification are incorporated herein by reference to the extent that they supplement, explain, provide a background for or teach methodology or techniques employed herein.

What is claimed is:

1. A device for removing water from a pool cover in conjunction with a pool cover pump having an outlet, the device comprising:
a connector configured for coupling to the pool cover pump outlet;
tubing having first and second ends, the first end joined to the connector; and
a nozzle joined to the second end of the tubing;
the tubing and nozzle configured to expel water from the pool cover pump outwardly and away from the pool cover pump.

2. The device of claim 1, wherein the tubing and nozzle are configured to additionally expel the water from the pool cover pump upwardly.

3. The device of claim 1, wherein the tubing and nozzle are configured to additionally expel the water from the pool cover pump over the pool cover pump.

4. The device of claim 1, wherein the nozzle is configured to expel water from the pool cover pump in a stream.

5. The device of claim 1, wherein the nozzle is configured to expel water from the pool cover pump in a spray.

6. The device of claim 1, wherein the tubing includes a first portion that extends radially outward from the connector, a second portion angling outwardly from the first portion, and a third portion that extends upwardly from the second portion, the nozzle joined to the third portion.

7. The device of claim 1, wherein the tubing wraps around the pool cover pump.

8. The device of claim 7, wherein the tubing comprises a first tubing portion that extends from the connector and around the pool pump, and a second tubing portion that extends upwardly and outwardly from the first tubing portion, the nozzle joined to an end of the second tubing portion that is distal the first tubing portion.

9. The device of claim 8, wherein the second tubing portion is removably connected to the first tubing portion.

10. A water ejection spout for a pool cover pump having a pump outlet, the water ejection spout comprising:
a connector configured for coupling to the pool cover pump outlet;
a tube having first and second ends, the connector coupled to the first end; and
a nozzle joined to the second end of the tube;
the tube and nozzle configured to expel water from the pool cover pump outwardly and away from the pool cover pump.

11. The water ejection spout of claim 10, wherein the tube and nozzle are configure to expel water from the pool cover pump outwardly and away from the pool cover pump in a directed stream.

12. The water ejection spout of claim 10, wherein the tube and nozzle are configure to expel water from the pool cover pump outwardly and away from the pool cover pump in a directed spray.

13. The water ejection spout of claim 10, wherein the tube and nozzle are configured to additionally expel the water from the pool cover pump over the pool cover pump.

14. The water ejection spout of claim 10, wherein the tube includes a first tube portion that extends radially outward from the connector, a second tube portion angling outwardly from the first tube portion, and a third tube portion that extends upwardly from the second tube portion, the nozzle joined to the third tube portion.

15. The water ejection spout of claim 10, wherein the tube wraps around the pool cover pump.

16. The water ejection spout of claim 15, wherein the tube comprises a first tube portion that extends from the connector and around the pool pump, and a second nozzle joined to an end of the second tube portion that is distal the first tube portion.

17. The water ejection spout of claim 16, wherein the second tube portion is removably connected to the first tube portion.

18. A method for removing water from a pool cover comprising:
providing a pool cover pump having a pump outlet;
connecting a water ejection spout according to claim 10 to the pump outlet;
orienting the water ejection spout to direct expelled water outside of the pool cover; and
turning on the pool cover pump.
